(19) United States
(12) Patent Application Publication
(10) Pub. No.: US 2008/0269924 A1
(43) Pub. Date: Oct. 30, 2008

(54) METHOD OF SUMMARIZING SPORTS VIDEO AND APPARATUS THEREOF

(76) Inventors: Chen-Hsiu HUANG, Chi-Lung (TW); Ho-Chao HUANG, Taipei (TW)

Correspondence Address: NORTH AMERICA INTELLECTUAL PROPERTY CORPORATION, P.O. BOX 506, MERRIFIELD, VA, 22116, US

(21) Appl. No.: 11/741,775

(22) Filed: Apr. 30, 2007

(51) Int. Cl. G06F 19/00

(52) U.S. Cl. 700/91; 345/619; 434/247

(57) ABSTRACT

The present invention discloses a method of summarizing a sports video. The method includes the following steps: selecting at least a summarization style, wherein the summarization style is defined with at least an event; analyzing the sports video to extract at least a scene segment from the sports video corresponding to the at least one event defined in the summarization style; and summarizing the sports video based on the at least one scene segment to generate a summarized video corresponds to the summarization style.

### BACKGROUND OF THE INVENTION

1. Field of the Invention

The present invention relates to a method of summarizing a sports video and apparatus thereof, and more particularly, to a method of summarizing the sports video by adaptively selecting a specific type template of an event in the sports video, and an apparatus thereof.

2. Description of the Prior Art

With rapid development in digital television systems, video entertainment products have become common in daily life, therefore more and more entertainment videos are being generated. However, content of an entire video will take a long time for a viewer to watch. For example, an entire baseball game normally lasts at least two hours. The baseball game video content will comprise a plurality of events performed by two baseball teams. A viewer may wish to only watch certain events from the whole baseball game video. Therefore, to meet user requirements, various tools have been developed for processing the baseball game video to generate a summarized video version.

According to the prior art, one of the conventional methods is to detect all the important events in the baseball game video, in which the events always represent an exciting event or action during the baseball game. For example, the event may be hitting a home run, a double, a triple, catching a pop fly, etc. A time interval will be assigned to each video segment that corresponds to the event categorization. The conventional method then extracts all of the video segments corresponding to the particular scene. However, the prior art does not have the mechanism of selecting the events. In other words, the user can only have one version of the summarized video by using the prior art method. For example, some viewers may like to enjoy the summarized video that only has the home run segments, or home runs hit by a specific team. Therefore, the prior art summarizing tools are not capable of satisfying viewers' demands.

U.S. Pat. No. 6,905,339 discloses a virtual sport instruction. This prior art includes a sport performance evaluation method and system. The method includes storing a user-defined physical profile, displaying a set of images where each image in the set depicts a different variation of an element of imperfect sport performance, and selecting at least one image in the set most closely depicting an element of imperfect sport performance exhibited by a user who is associated with the user-defined physical profile. The method also includes diagnosing at least one cause for the imperfect sport performance based upon the stored selected image and the stored user-defined physical profile. The system can include a user-defined physical profile and at least one set of images depicting an element of imperfect sport performance where each image in the set depicts a different variation of the element. The system can also include at least one data repository and at least one computing device.

U.S. Pat. No. 5,557,717 discloses a method and device for graphical display of a sporting contest. This prior art utilizes a device for creating and displaying a graph describing the dynamic of a game. The graph is created by displaying a curve representative of the score of the game at significant moments in the game. This is superimposed upon information describing these significant moments. Markers that connect these significant instances with the score are also shown.

### SUMMARY OF THE INVENTION

Therefore, one of the objectives of the present invention is to summarize a sports video by adaptively selecting a specific type of of event in the sports video.

According to an embodiment of the present invention, a method of summarizing a sports video is disclosed. The method comprises the following steps: selecting at least a summarization style, wherein the summarization style is defined with at least an event; analyzing the sports video to extract at least a scene segment from the sports video corresponding to the at least one event defined in the summarization style; and summarizing the sports video based on the at least one scene segment to generate a summarized video corresponds to the summarization style.

According to another embodiment of the present invention, a method of summarizing a sports video is disclosed. The method comprises the following steps: analyzing the sports video to determine at least a summarization style, wherein the at least one summarization style is defined by at least an event; selecting at least one summarization style; extracting at least a scene segment from the sports video corresponding to the at least one event defined in the summarization style; and summarizing the sports video based on the at least one scene segment to generate a summarized video corresponds to the summarization style.

According to yet another embodiment of the present invention, an apparatus for summarizing a sports video is disclosed. The apparatus comprises a style selecting block, an analyzing block, and a summarizing block. The style selecting block selects at least a summarization style, wherein the summarization style is defined with at least an event; the analyzing block analyzes the sports video to extract at least a scene segment from the sports video corresponding to the at least one event defined in the summarization style; and the summarizing block summarizes the sports video based on at least the at least one scene segment to generate a summarized video corresponds to the summarization style.

According to yet another embodiment of the present invention, an apparatus for summarizing a sports video is disclosed. The apparatus comprises an analyzing block, a style selecting block, an operating block, and a summarizing block. The analyzing block analyzes the sports video to determined at least a summarization style, wherein the at least one summarization style is defined by at least an event; the style selecting block selecting the at least one summarization style; the operating block extracts at least a scene segment from the sports video corresponding to the at least one event defined in the summarization style; and the summarizing block summarizes the sports video based on the at least one scene segment to generate a summarized video corresponds to the summarization style.

### BRIEF DESCRIPTION OF THE DRAWINGS

FIG. 1 is a flow chart illustrating a method of summarizing a sports video according to an embodiment of the present invention.

FIG. 2 is a diagram illustrating an apparatus for processing the sports video according to an embodiment of the present invention.

FIG. 3 is a diagram illustrating a timing diagram of the baseball game where only the home runs that performed by a team A.

FIG. 4 is a timing diagram illustrating the summarized video of all scene segments of hitting a home run performed by team A during the baseball game.

FIG. 5 is a flow chart illustrating a method of summarizing a sports video according to another embodiment of the present invention.

FIG. 6 is a diagram illustrating an apparatus for processing the sports video according to another embodiment of the present invention.

### DETAILED DESCRIPTION

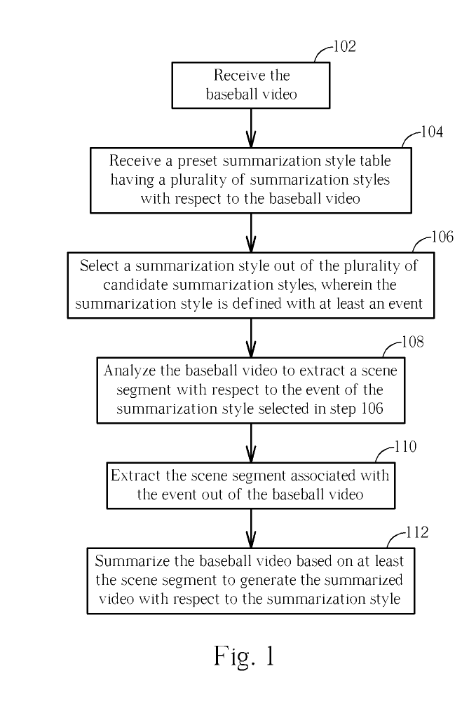

Please refer to FIG. 1. FIG. 1 is a flowchart illustrating a method of summarizing a sports video according to an embodiment of the present invention. The method is utilized for summarizing a video of a sports competition to generate the corresponding summarized video version. Furthermore, in order to describe the spirit of the present invention more clearly, the sports competition is a baseball game in the following description, but this is not meant to be the limitation of the present invention. In other words, other types of sports competitions, such as football games and basketball games for example, also belong to the scope of the present invention. Furthermore, in this embodiment, the baseball video utilized for generating the summarized video version is a recorded video, however, this is not a limitation of the present invention. Those skilled in this art can easily modify the method of the present invention to conform to the situation of a live sports program broadcasting. The method is briefly described as below:

Step 102: Receive the baseball video;

Step 104: Receive a preset candidate summarization style table having a plurality of summarization styles with respect to the baseball video;

Step 106: Select a summarization style out of the plurality of candidate summarization styles, wherein the summarization style is defined with at least an event;

Step 108: Analyze the baseball video to extract a scene segment with respect to the event of the summarization style selected in step 106;

Step 110: Extract the scene segment associated with the event out of the baseball video; and

Step 112: Summarize the baseball video based on at least the scene segment to generate the summarized video with respect to the summarization style.

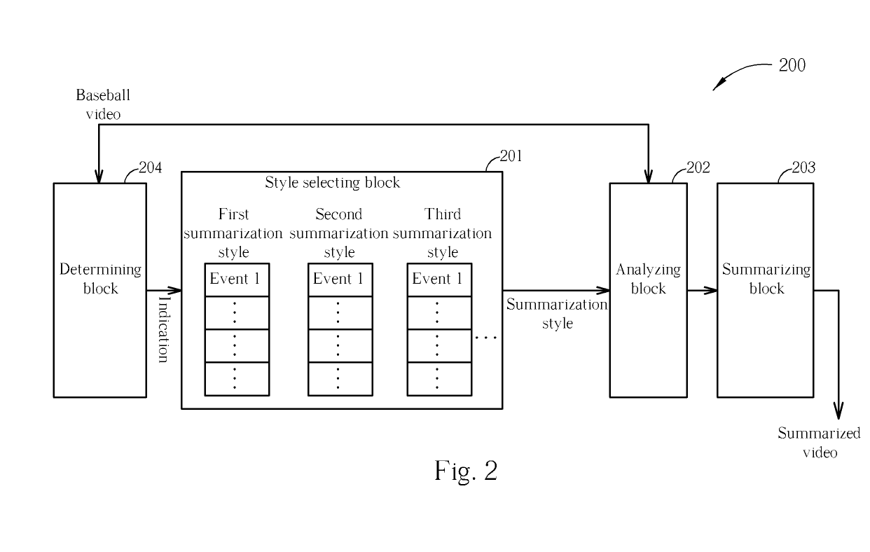

Provided that substantially the same result is achieved, the steps of the flowchart shown in Fig.1 need not be in the exact order shown and need not be contiguous. Please refer to FIG. 2. FIG. 2 is a diagram illustrating an apparatus 200 for processing the sports video according to an embodiment of the present invention. For brevity, the apparatus 200 is utilized for processing the above-mentioned baseball video, and utilizes the aforementioned method shown in FIG. 1 to summarize the baseball video to thereby generate the summarized video version. The apparatus 200 comprises a style selecting block 201, an analyzing block 202, and a summarizing block 203. Please note that, in order to describe the spirit of the present invention more clearly, the apparatus 200 further comprises a determining block 204 as shown in FIG. 2. The determining block 204 outputs an indication to the style selecting block 201 to indicate that the incoming video is a baseball game video. Please note that, according to the present invention, the indication can be manually inputted by a user or automatically generated through the detection of the inputted video. In step 102, when the apparatus 200 receives the baseball video, the determining block 204 outputs the baseball game indication to the style selecting block 201. As known to the baseball fan, there are many exciting scenes that may occur in a baseball game, especially major fluctuation in score, such as a home run, a double, a triple, catching a pop fly, etc. Therefore, the style selecting block 201 loads the preset candidate summarization style table having a plurality of summarization styles with respect to the exciting scene categories of the baseball video. For example, a team style can be represented by a first summarization style and the team style is defined by the exciting events corresponding to a specific team, a player style can be represented by a second summarization style and the player style is defined by the exciting events corresponding to a specific player, an offensive style can be represented by a third summarization style and the offensive style is defined by the offensive events in the baseball game, a defensive style can be represented by a fourth summarization style and the defensive style is defined by the defensive events in the baseball game, a pitching style can be represented by a fifth summarization style and the pitching style is defined by the pitching events in the baseball game, and so on. For example, when some users wish to view the exciting events scenes that performed by a team A, which is the first summarization style, the style selecting block 201 supports classification of the exciting event (i.e., event 1, event 2, . . . ) scenes of team A as shown in FIG. 2. The exciting events can be the home run, the double, the triple, the catching a pop fly, and other exciting events that performed by the team A, the exciting events can be chosen by the user or a computer system. For brevity, a first home run scene by team A can be represented by the event 1, a second home run scene by team A can be represented by the event 2, a third home run by team A can be represented by the event 3, etc Accordingly, the user of the apparatus 200 can choose any preferred summarization style to create the summarized video (step 106).

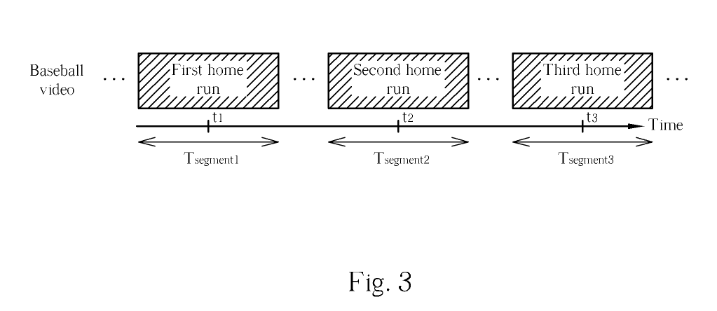

In step 108, when the user selects the summarization style of team style out of the plurality of candidate summarization styles, the analyzing block 202 analyzes the baseball video to extract the scene segments with respect to the exciting events of the summarization style selected by the style selecting block 201. Similarly, in order to describe this embodiment more clearly, it is assumed that the exciting events be the home run that performed by team A. Please refer to FIG. 3. FIG. 3 is a diagram illustrating a timing diagram of the baseball game, in which only the scene segments associated with hitting the home runs that performed by team A are shown by oblique line sectors, and the first home run is happened at time t₁, the second home run is happened at time t₂, the third home run is happened at time t₃. Please note that the segment lengths T_{segment1}, T_{segment2}, and T_{segment3} of the scene segments vary according to a total length Tₜₒₜₐₗ of the summarization video. In other words, when the total length Tₜₒₜₐₗ that set by the user is longer, then the segment lengths T_{segment1}, T_{segment2}, and T_{segment3} of each scene segment can be assigned more longer accordingly, and vice versa. Then, the home run scene segments performed by team A are assigned with respective segment lengths by the analyzing block 202.

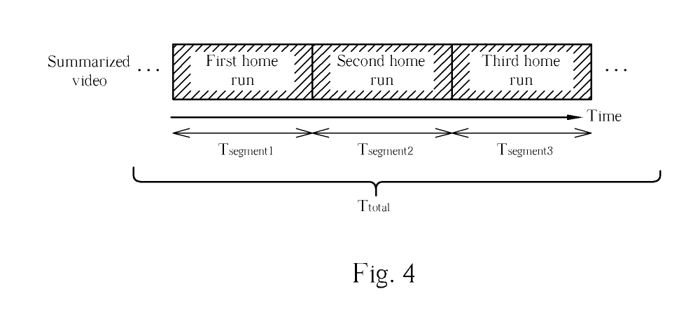

After the analyzing block 202 assigns the segment length to the scene segment corresponding to the exciting event, the analyzing block 202 then extracts the scene segment associated with the exciting event from the sports video according to the assigned segment length (step 110). Therefore, according to the embodiment of the present invention, all home run scene segments performed by team A are extracted. Then, in step 112, the summarizing block 203 summarizes the extracted home run scene segments performed by team A to generate the summarized video having the total length of Tₜₒₜₐₗ. Please refer to FIG. 4. FIG. 4 is a timing diagram illustrating the summarized video of all of the home run scene segments performed by team A in the baseball game. Accordingly, the summarized video will be more adaptable to the preference of the viewer.

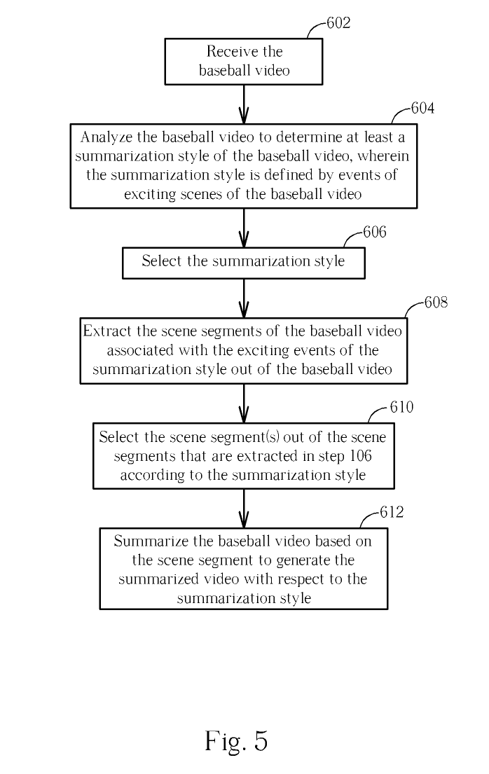

Please refer to FIG. 5. FIG. 5 is a flow chart illustrating a method of summarizing a sports video according to another embodiment of the present invention. Similar to the aforementioned embodiment, the method is utilized for summarizing a video of a sports competition to generate the corresponding summarized video version. The method of this embodiment is briefly described as below:

Step 602: Receive the baseball video;

Step 604: Analyze the baseball video to determine at least a summarization style of the baseball video, wherein the summarization style is defined by events of exciting scenes of the baseball video;

Step 606: Select the summarization style;

Step 608: Extract the scene segments of the baseball video associated with the exciting events of the summarization style out of the baseball video;

Step 610: Select the scene segment(s) out of the scene segments that are extracted in step 106 according to the summarization style; and

Step 612: Summarize the baseball video based on the scene segment to generate the summarized video with respect to the summarization style.

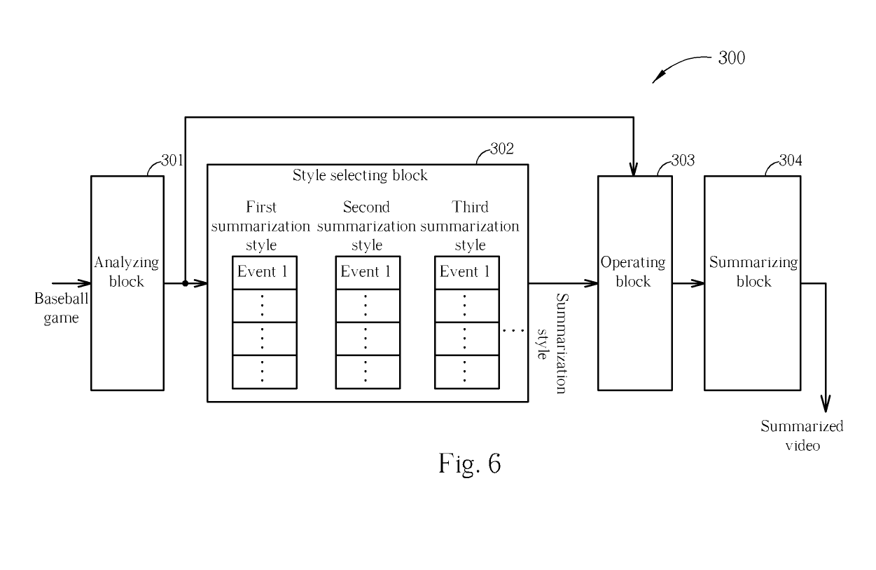

Provided that substantially the same result is achieved, the steps of the flowchart shown in FIG. 5 need not be in the exact order shown and need not be contiguous. Please refer to FIG. 6. FIG. 6 is a diagram illustrating an apparatus 300 for processing the sports video according to another embodiment of the present invention. For brevity, the apparatus 300 is utilized for processing the above-mentioned baseball video, and utilizes the aforementioned method shown in FIG. 5 to summarize the baseball video to thereby generate the summarized video version. In this embodiment, the apparatus 300 comprises an analyzing block 301, a style selecting block 302, an operating block 303, and a summarizing block 304. In step 602, when the apparatus 300 receives the baseball video, the analyzing block 301 analyzes the baseball video to determine the summarization styles of the baseball video, wherein the summarization styles is defined by the events of exciting scenes of the baseball video. In a baseball game, the exciting scenes can be a home run, a double, a triple, catching a pop fly, etc. The analyzing block 301 then extracts the scene segments of the baseball video associated with the exciting events out of the baseball video (step 606). Meanwhile, the style selecting block 302 generates the summarization style table of categorized exciting events according to all of the scenes, as shown in FIG. 6 (step 608). For example, a team style can be represented by a first summarization style and the team style is defined by the exciting events corresponding to a specific team in the baseball game, a player style can be represented by a second summarization style and the player style is defined by the exciting events corresponding to a specific player in the baseball game, an offensive style can be represented by a third summarization style and the offensive style is defined by the offensive events in the baseball game, a defensive style can be represented by a fourth summarization style and the defensive style is defined by the defensive events in the baseball game, a pitching style can be represented by a fifth summarization style and the pitching style is defined by the pitching events in the baseball game, and so on. Similar to the above-mentioned embodiment, when some users wish to view the exciting scenes that performed by a team A, which is the first summarization style, the style selecting block 302 supports classification of the exciting event (i.e., event 1, event 2, . . . ) scenes of team A as shown in FIG. 6. The exciting events can be the home run, the double, the triple, the catching a pop fly, and other exciting events that performed by the team A, the exciting events can be chosen by the user or a computer system. For example, a first home run scene by team A can be represented by the event 1, a second home run scene by team A can be represented by the event 2, a third home run by team A can be represented by the event 3, etc.

After the summarization style table is generated, the user of the apparatus 300 can choose any preferred summarization style to create the summarized video. In step 610, when the user selects the summarization style of team style out of a plurality of candidate summarization styles, the operating block 303 selects the scene segment out of the scene segments extracted in step 606 according to the summarization style. In order to describe this embodiment more clearly, it is assumed that the exciting events be the home run that performed by team A. Similar to the above-mentioned embodiment shown in FIG. 3, the scene segments of hitting home run performed by team A are shown by oblique line sectors; in which the first home run is happened at time t₁, the second home run is happened at time t₂, the third home run is happened at time t₃. Please note that the segment lengths T_{segment1}, T_{segment2}, and T_{segment3} of the scene segment vary according to the total length Tₜₒₜₐₗ of the summarization video. In other words, when the total length Tₜₒₜₐₗ that set by the user is longer, then the segment lengths T_{segment1}, T_{segment2}, and T_{segment3} of each scene segment can be assigned more longer accordingly, and vice versa. Then, the home run scene segments performed by team A are assigned with respective segment lengths by the operating block 303.

In step 614, the summarizing block 304 summarizes the baseball video based on the scene segment(s) to generate the summarized video with respect to the summarization style. Therefore, according to this embodiment of the present invention, the summarizing block 304 summarizes the extracted home run scene segments performed by team A to generate the summarized video. Similar to the above-mentioned embodiment of FIG. 5, the summarized video of all of the home run scene segments performed by team A in the baseball game is generated. Accordingly, the summarized video will be more adaptable to the preference of the viewer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of summarizing a sports video, comprising:
selecting at least a summarization style, wherein the summarization style is defined with at least an event;
analyzing the sports video to extract at least a scene segment from the sports video corresponding to the at least one event defined in the summarization style; and
summarizing the sports video based on the at least one scene segment to generate a summarized video corresponds to the summarization style.

2. The method of claim 1, wherein the sports video is a baseball game video.

3. The method of claim 1, wherein the summarization style is a preset style.

4. The method of claim 1, wherein the at least one event of the summarization style is user-defined.

5. The method of claim 1, wherein the summarization style is a team style, and the team style is defined by the at least one event corresponding to a specific team.

6. The method of claim 1, wherein the summarization style is a player style, and the player style is defined by the at least one event corresponding to a specific player.

7. The method of claim 1, wherein the summarization style is an offensive style, and the offensive style is defined by the at least one offensive event.

8. The method of claim 1, wherein the summarization style is a defensive style, and the defensive style is defined by the at least one defensive event.

9. The method of claim 1, wherein the summarization style is a pitching style, and the pitching style is defined by the at least one pitching event.

10. The method of claim 1, wherein the scene segment of the event is an entire play or a part of major fluctuation in score of the play.

11. The method of claim 1, wherein the length of each of the scene segments varies according to a desired length of the summarization video.

12. A method of summarizing a sports video, comprising:
analyzing the sports video to determine at least a summarization style, wherein the at least one summarization style is defined by at least an event;
selecting the at least one summarization style;
extracting at least a scene segment from the sports video corresponding to the at least one event defined in the summarization style; and
summarizing the sports video based on the at least one scene segment to generate a summarized video corresponds to the summarization style.

13. The method of claim 12, wherein the sports video is a baseball game video.

14. The method of claim 12, wherein the at least one event of the summarization style is user-defined.

15. The method of claim 12, wherein the summarization style is a team style, and the team style is defined by the at least one event corresponding to a specific team.

16. The method of claim 12, wherein the summarization style is a player style, and the player style is defined by the at least one event corresponding to a specific player.

17. The method of claim 12, wherein the summarization style is an offensive style, and the offensive style is defined by the at least one offensive event.

18. The method of claim 12, wherein the summarization style is a defensive style, and the defensive style is defined by the at least one defensive event.

19. The method of claim 12, wherein the summarization style is a pitching style, and the pitching style is defined by the at least one pitching event.

20. The method of claim 1, wherein the scene segment of the event is an entire play or a part of major fluctuation in score of the play.

21. The method of claim 1, wherein the length of each of the scene segments varies according to a desired length of the summarization video.

22. An apparatus for summarizing a sports video, comprising:
a style selecting block, for selecting at least a summarization style, wherein the summarization style is defined with at least an event;
an analyzing block, for analyzing the sports video to extract at least a scene segment from the sports video corresponding to the at least one event defined in the summarization style; and
a summarizing block, for summarizing the sports video based on the at least one scene segment to generate a summarized video corresponds to the summarization style.

23. The apparatus of claim 22, wherein the sports video is a baseball game video.

24. The method of claim 22, wherein the summarization style is a preset style.

25. The apparatus of claim 22, wherein the at least one event of the summarization style is user-defined.

26. The apparatus of claim 22, wherein the summarization style is a team style, and the team style is defined by the at least one event corresponding to a specific team.

27. The apparatus of claim 22, wherein the summarization style is a player style, and the player style is defined by the at least one event corresponding to a specific player.

28. The apparatus of claim 22, wherein the summarization style is an offensive style, and the offensive style is defined by the at least one offensive event.

29. The apparatus of claim 22, wherein the summarization style is a defensive style, and the defensive style is defined by the at least one defensive event.

30. The apparatus of claim 22, wherein the summarization style is a pitching style, and the pitching style is defined by the at least one pitching event.

31. The apparatus of claim 22, wherein the scene segment of the event is an entire play or a part of major fluctuation in score of the play.

32. The apparatus of claim 22, wherein the length of each of the scene segments varies according to a desired length of the summarization video.

33. An apparatus of summarizing a sports video, comprising:
an analyzing block, for analyzing the sports video to determine at least a summarization style, wherein the at least one summarization style is defined by at least an event;
a style selecting block, for selecting the at least one summarization style;
an operating block, for extracting at least a scene segment from the sports video corresponding to the at least one event defined in the summarization style; and
a summarizing block, for summarizing the sports video based on the at least one scene segment to generate a summarized video corresponds to the summarization style.

34. The apparatus of claim 33, wherein the sports video is a baseball game video.

35. The method of claim 33, wherein the summarization style is a preset style.

36. The apparatus of claim 33, wherein the at least one event of the summarization style is user-defined.

37. The apparatus of claim 33, wherein the summarization style is a team style, and the team style is defined by the at least one event corresponding to a specific team.

38. The apparatus of claim 33, wherein the summarization style is a player style, and the player style is defined by the at least one event corresponding to a specific player.

39. The apparatus of claim 33, wherein the summarization style is an offensive style, and the offensive style is defined by the at least one offensive event.

40. The apparatus of claim 33, wherein the summarization style is a defensive style, and the defensive style is defined by the at least one defensive event.

41. The apparatus of claim 33, wherein the summarization style is a pitching style, and the pitching style is defined by the at least one pitching event.

42. The apparatus of claim 33, wherein the scene segment of the event is an entire play or a part of major fluctuation in score of the play.

43. The apparatus of claim 33, wherein the length of each of the scene segments varies according to a desired length of the summarization video.
